(19) United States
(12) Patent Application Publication
(10) Pub. No.: US 2009/0120312 A1
(43) Pub. Date: May 14, 2009

(54) Contrifugal Printing Apparatus And A Method Of Printing

(76) Inventor: Daniel Arthur Hall, Cambridge (GB)

Correspondence Address: BARNES & THORNBURG LLP, P.O. BOX 2786, CHICAGO, IL, 60690-2786, US

(21) Appl. No.: 11/660,068

(22) PCT Filed: Jul. 25, 2005
(86) PCT No.: PCT/GB05/02964

§ 371 Date: Jul. 27, 2007

(30) Foreign Application Priority Data
Aug. 12, 2004 (GB) 0417915.6

(51) Int. Cl. B41F 7/02

(52) U.S. Cl. 101/217

(57) ABSTRACT

A printing apparatus is disclosed which comprises a rotatable member, for example a cylinder (10) ratable about its longitudinal axis (12), drive means (16) for rotating the cylinder, means (22) for feeding liquid to the circumferential (20) surface of the cylinder to form droplets (18) of the liquid thereon, and means (32) for causing droplets to be released selectively from the cylinder (10) as it rotates. The droplets released are projected towards a substrate spaced from the cylinder, and control means are provided to monitor the rotation of the cylinder (10) and for controlling the droplet release means (32) to form a predetermined pattern of droplets on the substrate (44). The apparatus may provide a rapid supply of droplets, making it suitable for high throughout panting applications.

### FIELD OF THE INVENTION

The present invention relates to printing apparatus, and more particularly to apparatus which prints using projection of droplets of liquid. The invention also relates to a method of printing.

### BACKGROUND TO THE INVENTION

In a known type of printing apparatus, namely inkjet printers, the printed image is created by firing discrete droplets of ink from a drop firing chamber onto the surface to be printed. The throughput time of an inkjet printer is restricted by the time taken to refill the droplet firing chamber before the next droplet can be emitted.

### SUMMARY OF THE INVENTION

The present invention provides printing apparatus comprising a rotatable member, drive means for rotating the member, liquid feeding means for feeding liquid to the member to form droplets of the liquid thereon, droplet release means for causing droplets to be released selectively from the member as it rotates, such that the droplets are projected towards a substrate spaced from the member, and control means for controlling the droplet release means to form a predetermined pattern of droplets on the substrate.

The apparatus of the invention enables the generation of droplets at a high rate, facilitating high throughput.

It will be appreciated that most of the kinetic energy needed to project the drop onto the substrate can be derived from the rotation of the rotatable member. Thus a drop to be released from the member will already have most of the kinetic energy it needs to be projected onto the substrate before it is released, so that the droplet does not need to undergo the rapid linear acceleration and changes of acceleration to which a drop being ejected from a conventional inkjet printing head is subjected.

Control of the rotation of the member can ensure substantially constant initial droplet velocity (since any velocity imparted by the droplet release means may be small relative to the velocity of the rotatable member), and helps to ensure that initial drop velocity is substantially immune to variations in the temperature of the ink, ink composition or environmental parameters (for example air temperature, pressure, humidity etc.).

The system also enables relatively small drop sizes to be used and for high initial drop velocities to be achieved. In addition, the detached drop will have a much lower internal kinetic energy than a drop fired from the head of a forced ejection system. In addition, problems of jet-created ligatures or satellite droplets can be reduced or avoided, and higher polymer weight inks may be used as the release of a droplet from the member can involve a relatively low energy change in the former.

An apparatus according to the invention may also be advantageously incorporated in a system in which ink is transferred to an intermediate substrate and then, in turn, onto the substrate to be printed.

In an existing type of such printing apparatus a continuous layer of ink is deposited onto a first cylinder. A second cylinder with an engraved surface is then brought into contact with the first cylinder so that ink is transferred from the coated first cylinder onto the second cylinder. The second cylinder is subsequently rolled over the surface to be printed, creating the desired image thereon.

The transfer of ink from the first cylinder to the second is accomplished by bringing the cylinders close together so that the ink is transferred without forming discrete droplets. This requires that the surface velocities of the rotating cylinders are carefully matched. According to the present invention, printing may be achieved via an intermediate cylindrical surface by spacing the rotatable member from the intermediate surface. This enables the speed of rotation of the rotatable member to be controlled independently to that of the intermediate surface to achieve the desired velocity and frequency of droplet ejection therefrom.

In a preferred embodiment, the rotatable member is in the form of a cylinder. The cylinder is rotatable about its longitudinal axis, and the liquid feeding means is arranged to feed liquid to its circumferential surface.

The droplets may be formed on the member by the liquid feeding means at a predetermined array of droplet sites. The droplets are preferably formed in an array extending across the member in the longitudinal direction, so that droplets can be generated simultaneously in several locations.

The liquid feeding means may be arranged to replace droplets released from the rotatable member, thereby maintaining a supply of droplets for subsequent release from the member.

The droplet release means may comprise means for selecting droplets for subsequent release. According to one preferred embodiment, the droplet selecting means comprise a respective radiation detector for each droplet site, and a radiation source for selectively irradiating the detectors to select droplets to be released.

This selection serves to “prime” the selected sites for subsequent release of the respective droplets by the droplet release means. A trigger may be provided, along with means responsive to the trigger associated with each droplet site. As droplet sites reach a given point in their cycle of rotation on the rotatable member, the trigger is arranged to interact with the responsive means associated with primed droplet sites causing the release of the corresponding droplets.

Preferably, the responsive means is a phototransistor, and the trigger is a radiation source to which the phototransistor is responsive. The radiation source may be an LED array for example.

The ability to de-couple the drop selection process from the release process is technically beneficial, because one may require spatial precision and the other high power. Power and spatial precision together may be more difficult to achieve than separately.

Preferably, the droplet release means comprise a radiation source for irradiating the location of selected droplets. This radiation may serve to raise the temperature of the selected droplets, reducing their adherence to the member sufficiently for them to be released from the member.

Energy from the radiation source may be absorbed by the droplets. The droplets may be substantially transparent with respect to the radiation. In a preferred implementation, the energy is absorbed by the member below the respective droplet instead of, or as well as by the droplets. The temperature of the surface of the rotatable member below the selected droplet is thereby increased, heating the droplet sufficiently to cause its release.

In a further embodiment, the energy from the radiation source increases the viscosity of the selected droplets causing them to be released from the member. For example, the droplet liquid may comprise a photoreactive chemical, such as a UV curable material. The radiation is selected such that it cures an irradiated droplet into a solid or semi-solid state, thereby reducing the strength of its adhesion to the member and causing its release therefrom.

The droplet release means may comprise a respective droplet heater for each droplet site, a predetermined increase in the temperature of each heater causing the respective droplets to be released. The heater may comprise an electrically resistive element, for example.

The droplet release means may comprise means for electrostatically charging selected droplets, and means for creating an electric field to release the selected droplets.

In a further embodiment, the droplet release means comprise a respective mechanical actuator for each droplet site movable to release the respective droplet from the member. Each activator may be operated by a respective piezoelectric device. Alternatively, each actuator may comprise electrostatically deflectable material, and the droplet release means comprise means for generating an electric field to operate the respective actuator.

In another preferred variation in accordance with the invention, the droplet release means comprise means for creating a high voltage field to induce an electrostatic moment in selected droplets causing the selected droplets to be released from the member.

To encourage formation of discrete, well defined droplets on the surface of the rotatable member, the surface material of the member surrounding the droplet sites may repel the droplet liquid material.

Preferably, the liquid feeding means defines an opening, such that in use the liquid forms a meniscus at the opening which protrudes beyond the opening and contacts the rotatable member. Alternatively, the liquid feeding means may comprise absorbent material in contact with a supply of liquid, and also in contact with the rotatable member.

In a preferred embodiment, means are provided for absorbing some or all of the liquid from a droplet which was not released from the surface of the rotatable member. The composition of droplets remaining on the surface of the rotatable member may change over time, owing to evaporation for example. In the case of liquid ink, the solvent used in pigmented dispersions will often evaporate, thereby increasing the pigment concentration in the droplets which may be undesirable. The droplet absorbing means allows maintenance of the composition and/or volume of the droplets by enabling replacement of liquid of droplets carried by the cylinder with “fresh” liquid from a reservoir. In a preferred embodiment of this configuration, the liquid feeding means provides the droplet absorbing means.

In arrangements where the liquid feeding means forms a meniscus contacting the cylinder, as the meniscus cones into contact with a droplet, liquid absorbed from the droplet and as the droplet site moves away from the meniscus a new droplet is formed using “fresh” liquid drawn from the chamber.

The droplet absorbing means may be operable to feed absorbed droplets into a reservoir of liquid from which liquid is drawn for feeding onto the rotatable member.

In an embodiment where the liquid feeding means provides the droplet absorbing means, the liquid feeding means may comprise a chamber having an inlet and an outlet connected to a reservoir means, and means for circulating liquid between the chamber and the reservoir means.

The present invention further provides a method of printing comprising the steps of rotating a rotatable member, feeding liquid to the surface of the member to form droplets thereon, and causing droplets to be released selectively from the member, such that the droplets are projected towards a substrate spaced from the member to form a predetermined pattern of droplets on the substrate.

### BRIEF DESCRIPTION OF THE DRAWINGS

Embodiments of the invention will now be described by way of example and with reference to the accompanying schematic drawings wherein:

FIG. 1 shows a printing apparatus according to a first embodiment of the invention;

FIG. 2(a) shows a perspective view of a rotatable cylinder for use in the apparatus of FIG. 1;

FIG. 2(b) shows an enlarged cross-sectional side view of part of the cylinder of FIG. 2(a);

FIG. 3(a) shows a perspective view of liquid feeding means for use in the apparatus of FIG. 1;

FIGS. 3(b) and 3(c) show further embodiments of liquid feeding means for use in the apparatus of FIG. 1;

FIG. 3(d) shows an embodiment of liquid feeding means in combination with droplet absorbing means for use in the apparatus of FIG. 1;

FIG. 4 shows a printing apparatus according to a second embodiment of the invention;

FIG. 5 shows part of a printing apparatus according to a third embodiment of the invention;

FIGS. 6(a) to 6(f) show features of droplet release means according to a fourth embodiment of the invention; and

FIG. 7 shows a printing apparatus including the droplet release means of FIGS. 6(a) to 6(f).

### DETAILED DESCRIPTION

It should be noted that the Figures are diagrammatic and not drawn to scale. Relative dimensions and proportions of these Figures have been shown exaggerated or reduced in size, for the sake of clarity and convenience in the drawings. The same reference signs are generally used to refer to corresponding or similar features in modified and different embodiments.

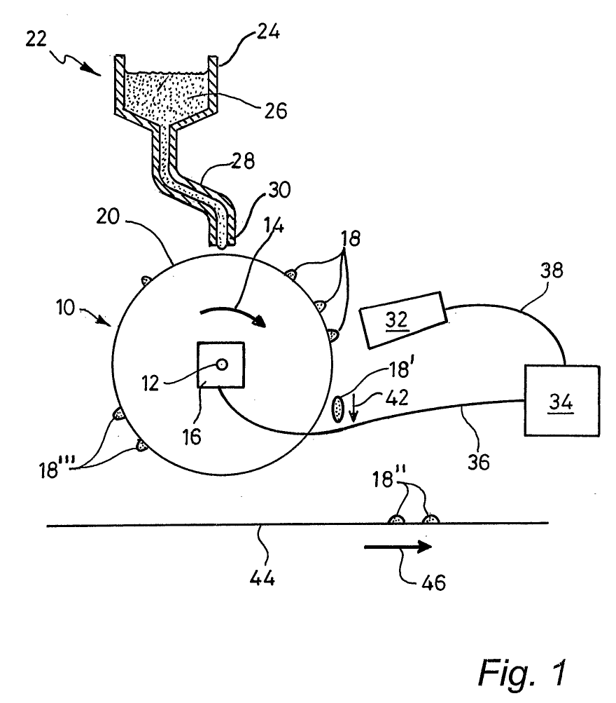

The printing apparatus of FIG. 1 has a cylinder 10 rotatable about its longitudinal axis 12 which as shown is perpendicular to the plane of the figure. In use of the apparatus as illustrated, the cylinder rotates around axis 12 in the direction indicated by arrow 14. The cylinder is rotated by drive means 16 in the form of a motor. Droplets 18 of substantially equal volume are formed on the circumferential surface 20 of the cylinder 10 by liquid feeding means 22. The liquid feeding means comprises a reservoir 24 containing liquid 26 (such as an ink, for example) connected to a tube 28 having an open distal end 30, from which droplets are emitted onto the cylinder.

Typically, the droplets may have a diameter of less than 300 microns—40 microns for example—and a volume less than 500 pL-20 pL for example.

Droplet release means 32 cause selected droplets to be released from the cylinder, as will be described in more detail below. Control means 34 monitor rotation of the cylinder via an electrical connection 3b to an appropriately located sensor, in the drive means 16, for example, and control operation of the droplet release means 32 via a further electrical connection 38.

A released droplet 18′ is shown in FIG. 1 which has broken contact with the cylinder 10 and is travelling in a direction indicated by arrow 42, approximately tangentially with respect to the circumferential cylinder surface 20. The droplet velocity may be approximately equal to the surface velocity of the cylinder and is typically 2 m/s or more. Released droplets land on a substrate 44 moving relative to the circumferential surface of the cylinder in a direction indicated by arrow 46, to form a desired, predetermined pattern thereon. In a high throughout printing application, the substrate may be moving typically at a speed of around 1 m/s or greater relative to the cylinder. Droplets 18′″ which are not selected for release from the cylinder remain in place for possible selection during the next revolution of the cylinder. Means may be provided to refresh these drops, which are described below.

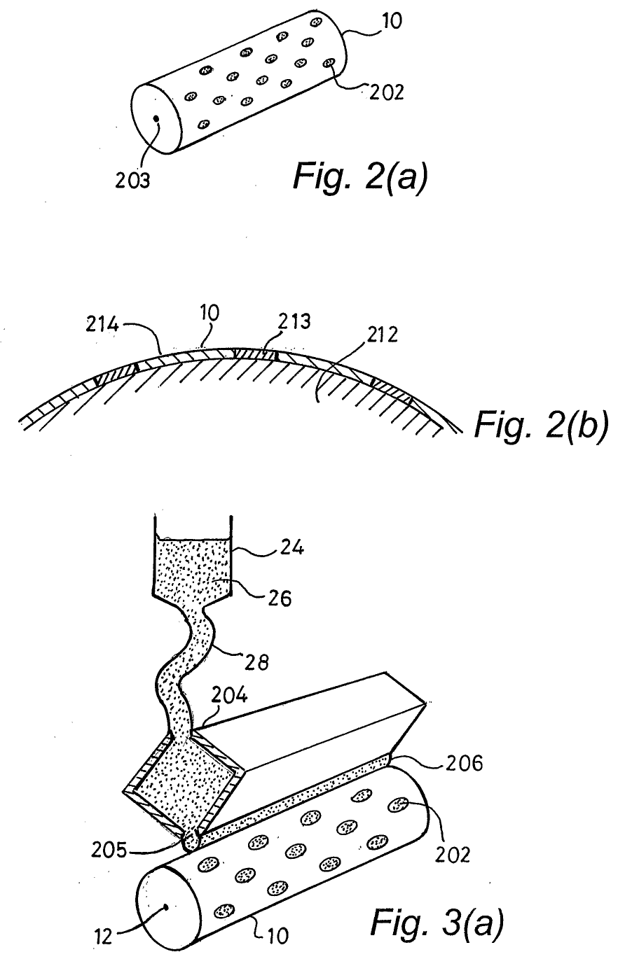

FIG. 2(a) shows a cylinder 10 having an array of droplet forming sites mutually spaced apart over the circumferential surface of the cylinder. The disc-shaped sites have a diameter or around 30 microns, and are spaced around 10 microns apart in the axial direction and around 200 to 300 microns apart in the circumferential direction on the cylinder surface. The cylinder may have a radius less than 4 cm, typically around 5 to 6 mm and an axial length of 300 mm, for example.

In use, the cylinder may rotate with a surface angular acceleration of over 10 m/s/s, typically of the order of 68,000 m/s/s. This corresponds to a cylinder with a radius of 6 mm rotating at approximately 32,000 revolutions per minute. Under these conditions, a released droplet may travel with an initial speed of around 20 m/s.

FIG. 2(b) illustrates a cross-section of cylinder 10 having two types of surface material coating: a hydrophobic coating 214 that repels liquid 26 and a hydrophilic coating 213 that attracts liquid 26. The hydrophobic surface areas 214 may be formed from a hydrophobic silane coating, for example a silane, siloxane or trichlorosilane treated substrate 212 of quartz, glass or ceramic material. The hydrophilic surface areas 213 may be formed from a metal, for example a 1 micron thick layer of gold, tantalum or molybdenum and which will also not bind chemically with the hydrophobic surface treatment. A hydrophobic additive to the liquid 26 may be used to renew the hydrophobic coating on the hydrophobic areas of the surface 211 without affecting the hydrophilic behaviour of the hydrophilic surface areas 213.

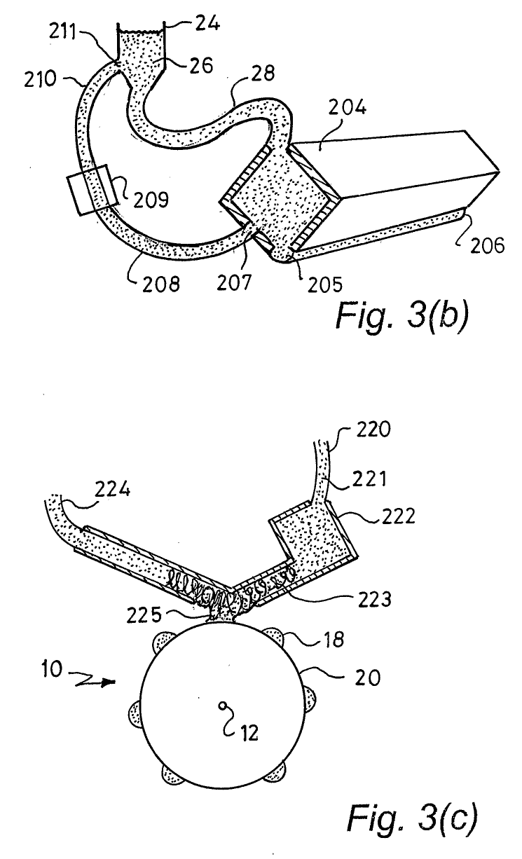

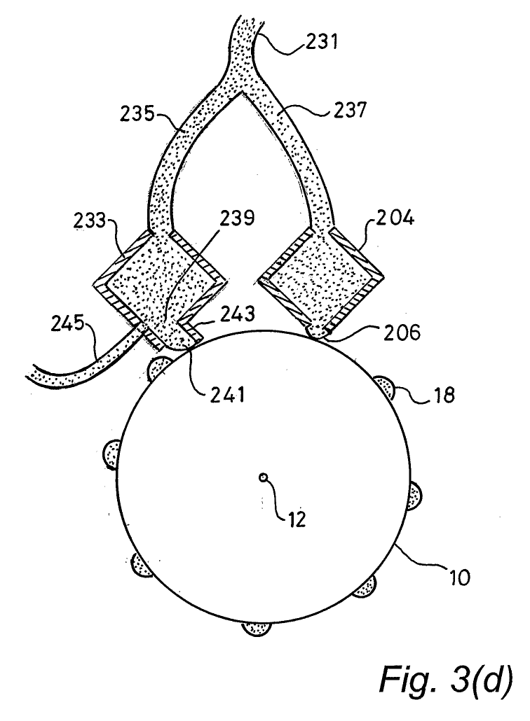

The liquid feeding means of FIG. 3(a) comprises a reservoir 24 containing liquid 26 connected by a tube 28 to an ink chamber 204 which defines a narrow open channel 205 positioned so that an ink meniscus 206 forms in contact with the surface of a cylinder 10 rotating around a central axis 12.

Channel 205 may be 100 mm long and 300 microns wide, for example, and positioned 200 microns from the surface of cylinder 10. The channel may typically be defined by edges of two opposing plates.

The liquid feeding means of FIGS. 3(b) and 3(c) also provide droplet absorbing and recirculation means. The ink chamber 204 contains an ink outlet 207 connected by a tube 208 to a pump 209 which pumps ink around the system, from the ink reservoir to the ink chamber and then back to the ink chamber, thereby recirculating and mixing the ink. The pump 209 is connected by a tube 210 to an inlet 211 to the ink reservoir 26. In this arrangement ink droplets not ejected from the cylinder are absorbed at the surface of meniscus 206 and then recreated as the respective droplet sites move past and away from the meniscus.

Ink that has traveled around the cylinder as a surface droplet is mixed with ink from the chamber 204 and recirculated to the ink reservoir 24, maintaining a substantially consistent formulation of liquid droplets on the surface of the rotating cylinder.

In FIG. 3(c), a liquid ink reservoir and pump (not shown) supply liquid to an inlet tube 220, supplying a liquid 221 to a chamber 222 containing liquid in contact with absorbent material 223. The absorbent material 223 may be cotton cloth for example. The liquid material is pumped through the absorbent material 223 to another part of the chamber which is connected by a tube 224 back to the liquid ink reservoir such that the liquid ink returns to the reservoir. Liquid 225 from the wetted absorbent material 223 is in contact with the surface 20 of a rotating cylinder 10, such that as the cylinder rotates droplets 18 are formed on the surface and travel around the axis 12 of the cylinder, until they are reabsorbed and mixed with the liquid in the absorbent material. In this way liquid that has traveled around the cylinder as a surface drop is mixed with liquid from the liquid reservoir, maintaining a consistent formulation of liquid drops on the surface of the rotating cylinder.

FIG. 3(d) shows an arrangement similar to those of FIGS. 3(a) and 3(b) which is modified to include liquid absorbing means separately from the liquid feeding means. A liquid reservoir and pump (not shown) supply liquid via inlets tube 231, 235 and 237 to both the ink feeding chamber 204 and an ink absorbing chamber 233. Like chamber 204, ink absorbing chamber may define an open channel 239 which is arranged to form an ink meniscus 241 in contact with the circumferential surface of cylinder 10.

A flexible member 243 is provided on the ink absorbing chamber 233 adjacent to the channel 239 which has a distal edge close to or in contact with the surface of cylinder 10. Member 243 serves to prevent formation of droplets by the meniscus 241, ensuring that absorbed ink is recirculated instead. The absorbed ink is fed from ink absorbing chamber back to the reservoir via an outlet tube 245.

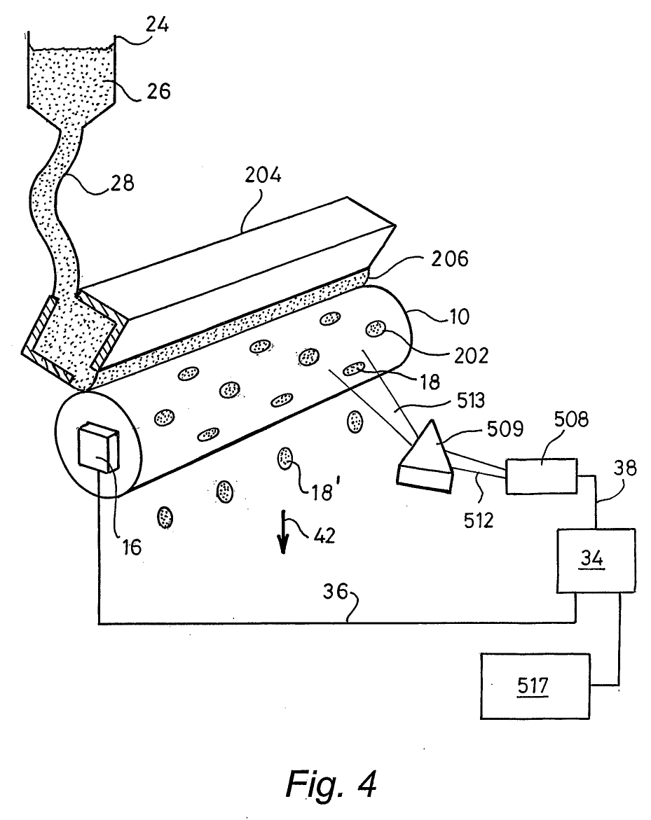

A preferred embodiment of a printing apparatus including the liquid feeding means of FIG. 3(a) is shown in FIG. 4. Drive means 16 includes an encoder which generates a signal along connection 36 indicative of the rotational orientation of the cylinder 10. Control means 34 receives drop selection control data from a control data store 517. The control means 34 is operable to transmit firing signals to the pulsed laser 508 along connection 38. The output light 512 from the pulsed laser is incident on rotatable prism 509 which deflects the laser light pulses 513 towards selected droplet sites on the rotating cylinder. The energy of each laser pulse may be absorbed by the corresponding droplet rapidly raising its temperature. Alternatively, the droplet liquid and laser pulse may be selected such that the liquid is substantially transparent with respect to the pulse, and most or all of the energy of the pulse is instead absorbed by the underlying droplet site. Heating of a selected droplet site or droplet by a laser pulse causes the respective droplet to be ejected from the cylinder surface. The heating is effected so as to reduce the adherence of the droplet, for example by forming a bubble at the droplet-droplet site interface.

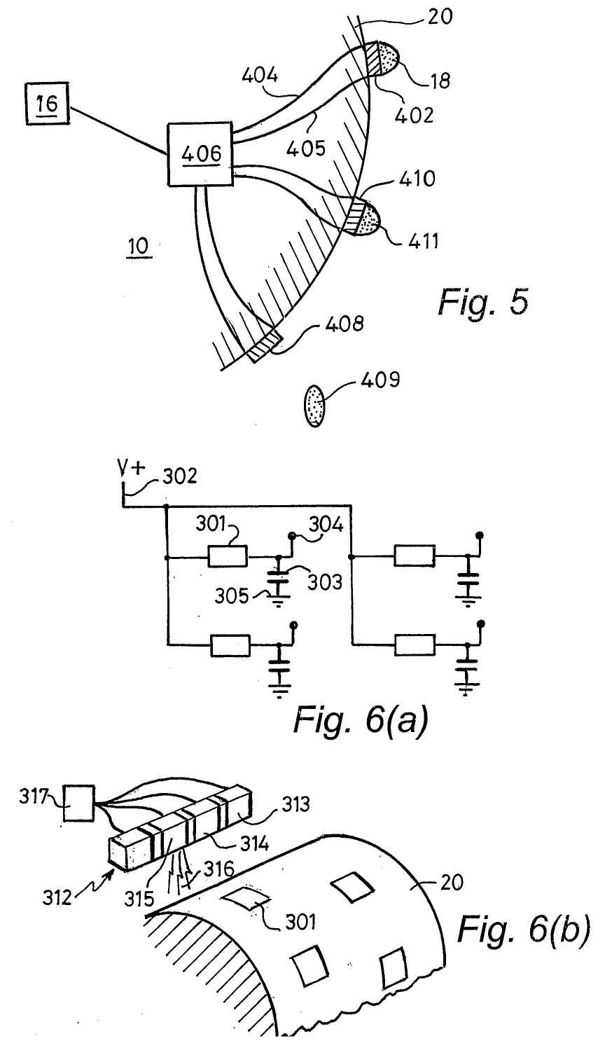

A further example of droplet release means of the invention is shown in FIG. 5. The circumferential surface 20 of a rotating cylinder 10 comprises electrically conductive droplet sites 402, 410, 408 which have respective droplets 18, 411 and 409 formed on them. The droplet sites may be formed of a conducting material with a high melting point such as tantalum. Motor 16 comprises a cylinder position encoder which is connected to control circuitry 406 which is operable to send an electrical signal to one or more droplet sites via electrically conducting wires for example, wires 404 and 405 connect to the site 402. In FIG. 5, a pulse of electricity has been sent to the electrically conducting site, raising its temperature, and thereby causing droplet 409 to be released from the surface of the cylinder.

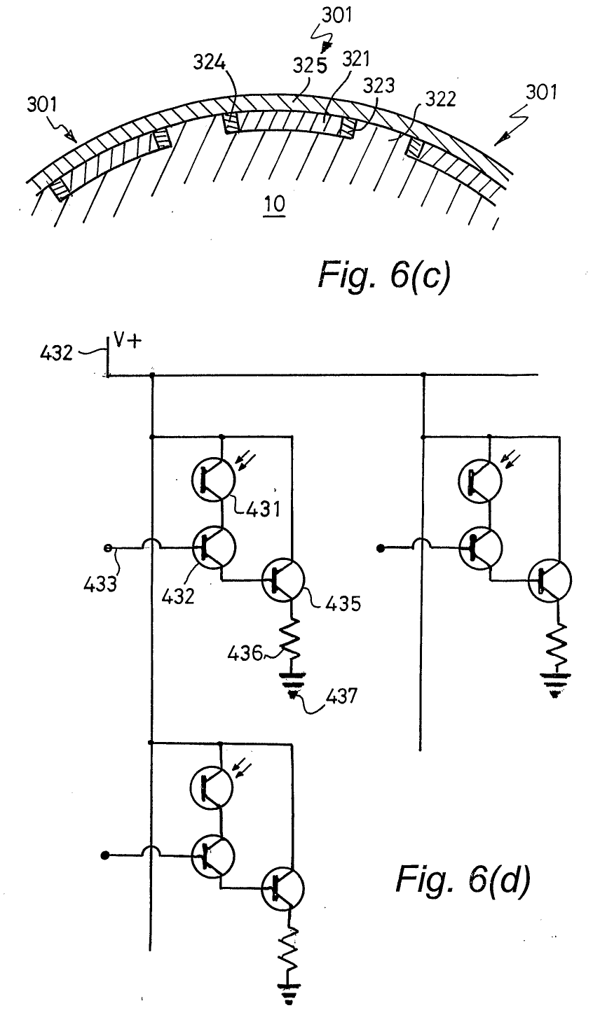

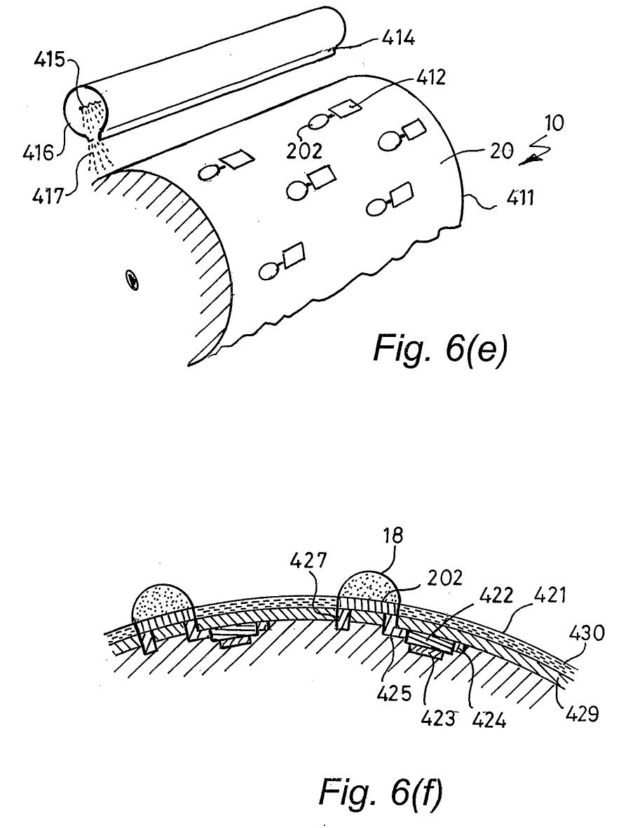

FIGS. 6(a) to (f) illustrate another preferred embodiment of droplet release means according to the invention. Referring firstly to the circuit diagram of FIG. 6(a), each droplet site on the cylinder has an associated light responsive conductor 301 connected at one end to an electric voltage supply 302. The other end of the light responsive conductor 301 is connected to one plate of a charge storage capacitor 303, so that a voltage at 304 may be used to control subsequent release of a droplet. The other plate of the capacitor 303 may be connected to ground 305 relative to the voltage supply.

As shown in FIG. 6(b), the conductors 301 are carried by the circumferential surface of the cylinder 20. An array 312 of light emitting diodes 313, 314 and 315 are fixed in a line above the surface of the rotating cylinder in a line parallel to the longitudinal axis of the cylinder. A control unit 317, responsive to data input (not shown) and a surface position encoder input (not shown) is able to select droplets for subsequent ejection by illuminating (for example, light rays 316 are shown) selected light responsive electrically conducting areas so a charge forms on an associated capacitor 303 (shown in FIG. 6(a)).

FIG. 6(c) shows an enlarged cross-sectional side view of the cylinder 10 of FIG. 6(b), to show light responsive areas 301 in more detail. A layer 321 of light responsive photoconductor material, for example amorphous selenium is embedded in the cylinder substrate material, for example quartz, with metal conductor connectors 324 and 323 connecting to other parts of the droplet release means circuitry. The conductors and photoconductor material are covered by a transparent surface layer 325 to prevent these materials from interacting with the liquid surface drop forming process. The surface coating 325 should be transparent to light from the light emitting devices 313 to 315 (see FIG. 6(b)). Each layer 321 may have an area of 20 by 50 microns, for example.

Each droplet site has an associated light responsive phototransistor circuit, as shown in FIG. 6(d). The base of a gating transistor 434 is connected via a control signal line 433 to the respective point 304 (see FIG. 6(a)) for the associated droplet site. The collector of the gating transistor is connected to the emitter of a phototransistor 431 and the emitter of the transistor is connected to the base of a power transistor 435. The collectors of the power transistor 435 and phototransistor 431 are connected to a supply voltage 432. The emitter of the power transistor is connected to an associated drop heating element 436 (for the respective droplet site) that comprises a resistive path to a relative earth connection 437. If an electrical charge is present at the selector input 433, the circuit passes a current through the heating element in response to light falling on the phototransistor 431.

After drop ejection, the charge at connection 433 (see FIG. 6(d)) to the base of gating transistor 434 needs to return to relative ground in the time taken by the droplet site to revolve around the cylinder, so that a new selection and ejection sequence may take place. Depending on the characteristics of the materials used and the speed and circumference of the cylinder, this may occur without additional discrete components or it may require the addition of a separate resistive path from connection 433 to relative ground 437. Similarly the charge stored at connection 433 should persist from the selection light exposure to the ejection light exposure, such that the selection effect on gating transistor 434 is still active when the ejection light exposure takes place. Depending on the characteristics of the materials used, the speed of the cylinder and the relative positions of the selection and ejection light sources, this may occur without additional discrete components or it may require the addition of a separate discrete capacitive component between connection 433 and relative ground 437 to store electric charge between selection and ejection light exposures.

An example of the distribution of an array of droplet sites 202 with associated phototransistor sites 412 is shown in FIG. 6(e). A linear light emitting device 414 is fixed above the surface of the cylinder 10, in a line parallel with the longitudinal axis of the cylinder. The light emitting device 414 consists of a light source 415 and a light focusing device 416 so that a stationary line of light falls on the cylinder, causing those droplets that have previously been selected by illumination of the respective conductor site 301 to be released.

FIG. 6(f) shows a cross-sectional side view of a cylinder incorporating the phototransistor circuit of FIG. 6(d). By way of illustration and for clarity, only the structure forming the power transistor 435 and droplet site are shown in the figure. The power transistor comprises a layer 422 of semiconducting material connected (which may typically comprise NPN or PNP regions which are not shown). The base region of the transistor is connected to a metal transistor base section 423, the collector region to a metal collector section 424, and the emitter region to a metal emitter section 425. The emitter section 425 forms an electrical connection to one side of a droplet site 202, above which a liquid droplet 18 has been formed. The opposite side of the droplet site 202 is connected via metal connector 427 to a relative earth.

The surface of the cylinder comprises a protective layer 429, which is formed of transparent material, for example fused silica, over the phototransistor and photoconductor components (not shown) associated with the droplet sites. The layer 429 is treated with a hydrophobic coating 430 which encourages liquid droplets 18 to form preferentially on the relatively hydrophilic material of the droplet site 202 (for example, tantalum or molybdenum) when the cylinder is wetted with a hydrogen bonding liquid, for example a water based ink.

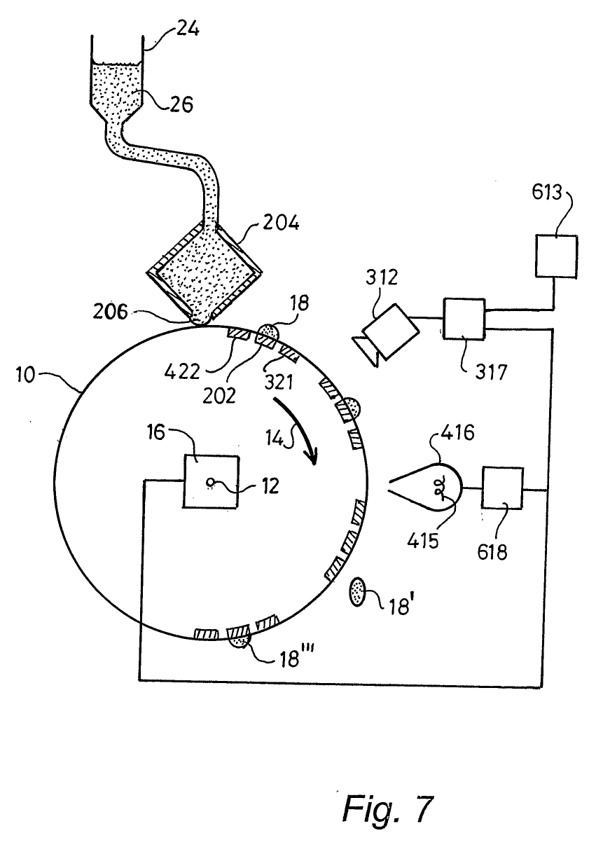

FIG. 7 shows a printing apparatus embodying the invention which incorporates the droplet release means described above with reference to FIGS. 6(a) to (f). In response to data from a data store 613 and the cylinder position encoded by an encoder in the drive means 16, each light in the array 312 may switch on to select a liquid drop for release from the cylinder surface. When illuminated by light source 415, phototransistors associated with droplet sites previously selected by light source 312 respond to light source 415, causing an electric current to be passed via the respective power transistor through the associated droplet site 202 and thereby heating the droplet site. This has the effect of causing the droplet to be released from the surface of the cylinder by reducing the net adherence of the surface drop to the cylinder 10.

The released droplets may land directly onto the surface to be printed. Alternatively, they may land on an intermediate printing surface, such as a roller, which is in contact with or subsequently moved into contact with the surface to be printed. A continuously variable image or pattern can thus be formed on the printed surface.

The droplet liquid material may be ink or paint, for example. It will be appreciated that a range of other liquids may be used, such as conductive, semi-conductive, insulative or photoresist materials used in the fabrication of printed electronic circuits; or liquids containing polymers, for example electropolymers.

1-24. (canceled)

25. Printing apparatus comprising a rotatable member, a drive for rotating the member, a liquid feeder for feeding liquid to the member to form droplets of the liquid thereon, a droplet releaser for causing droplets to be released selectively from the member as it rotates, such that the droplets are projected towards a substrate spaced from the member, and a controller for controlling the droplet releaser to form a predetermined pattern of droplets on the substrate.

26. Apparatus according to claim 25, wherein the rotatable member is a cylinder.

27. Apparatus according to claim 25, wherein the droplets are formed on the member by the liquid feeder at a predetermined array of droplet sites.

28. Apparatus according to claim 25, wherein the droplet releaser comprises a droplet selector for selecting droplets for subsequent release.

29. Apparatus according to claim 28, wherein the droplet selector comprises a respective radiation detector for each droplet site, and a radiation source for selectively irradiating the detectors to select droplets to be released.

30. Apparatus according to claim 25, wherein the droplet releaser comprises a radiation source for irradiating the locations of selected droplets.

31. Apparatus according to claim 30, wherein the radiation is absorbed by the member below the respective droplet.

32. Apparatus according to claim 27, wherein the droplet releaser comprises a respective droplet heater for each droplet site, a predetermined increase in the temperature of each heater causing the respective droplet to be released.

33. Apparatus according to claim 25, wherein the droplet releaser comprises an electrostatic charger for electrostatically charging selected droplets, and an electric field generator for creating an electric field to release the selected droplets.

34. Apparatus according to claim 27, wherein the droplet releaser comprises a respective mechanical actuator for each droplet site movable to release the respective droplet from the member.

35. Apparatus according to claim 34, wherein each actuator is operated by a respective piezoelectric device.

36. Apparatus according to claim 34, wherein each actuator comprises electrostatically deflectable material, and the droplet releaser comprises an electric field generator for generating an electric field to operate the respective actuator.

37. Apparatus according to claim 25, wherein the droplet releaser comprises a high voltage electric field generator for creating a high voltage field to induce an electrostatic moment in selected droplets causing the selected droplets to be released from the member.

38. Apparatus according to claim 30, wherein the radiation source generates an energy beam which increases the viscosity of the selected droplets causing them to be released from the member.

39. Apparatus according to claim 27, wherein the surface material of the member at the droplet sites attracts the droplet liquid material and the surface material of the member surrounding the droplet sites repels the droplet liquid material.

40. Apparatus according to claim 25, wherein the liquid feeder defines an opening such that in use the liquid forms a meniscus at the opening which protrudes beyond the opening and contacts the rotatable member.

41. Apparatus according to claim 25, wherein the liquid feeder comprises absorbent material in contact with a supply of liquid, and also in contact with the rotatable member.

42. Apparatus according to claim 25, comprising a droplet absorber for absorbing droplets from the rotatable member not released by the droplet releaser.

43. Apparatus according to claim 42, wherein the liquid feeder provides the droplet absorber.

44. Apparatus according to claim 43, wherein the droplet absorber is operable to feed absorbed droplets into a reservoir of liquid from which liquid is drawn for feeding onto the rotatable member.

45. Apparatus according to claim 44, wherein the liquid feeder comprises a chamber having an inlet and an outlet connected to a reservoir, and a liquid circulator for circulating liquid between the chamber and the reservoir.

46. A method of printing comprising the steps of rotating a rotatable member, feeding liquid to the surface of the member to form droplets thereon, and causing droplets to be released selectively from the member, such that the droplets are projected towards a substrate spaced from the member to form a predetermined pattern of droplets on the substrate.
